(19) United States
(12) Patent Application Publication
(10) Pub. No.: US 2010/0326149 A1
(43) Pub. Date: Dec. 30, 2010

(54) Lock Device Having A Hidden Locking Unit

(76) Inventors: Tsan-Lin Chang, Yuanlin Township (TW); Tsung-Ming Chang, Shetou Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/494,592

(22) Filed: Jun. 30, 2009

(51) Int. Cl. E05B 17/18

(52) U.S. Cl. 70/423

(57) ABSTRACT

A lock device includes a locking unit, a protective unit surrounding the locking unit, and a key unit extending through the protective unit and engaging the locking unit to lock or unlock the locking unit. The locking unit includes a lock head and a lock core. The protective unit includes a rotation member and a follower. The locking unit is sandwiched between the rotation member and the follower. The rotation member has a central portion provided with a passage aligning with the lock core and has a peripheral wall provided with an opening connected to the passage. Thus, the locking unit is hidden in the protective unit to prevent the lock core from being exposed from the protective unit so that a person cannot see the inner construction of the lock core and cannot unlock the lock core easily.

### BACKGROUND OF THE INVENTION

1. Field of the Invention

The present invention relates to a lock and, more particularly, to a lock device having a theftproof function.

2. Description of the Related Art

A conventional lock device 50 in accordance with the prior art shown in FIG. 7 comprises a lock head 51 mounted on a door 53 and a recessed lock core 52 rotatably mounted in the lock head 51. Thus, a key 54 is inserted into the core 52 to rotate the core 52 so as to lock or unlock the lock device 50. However, the lock core 52 is exposed outwardly from the lock head 51 so that a person can clearly see the inner construction of the lock core and can easily unlock the lock core by an unlocking tool. In addition, a thief can use a tool which is forcibly inserted into the lock core 52 to break the lock core 52 so as to unlock the lock core.

### BRIEF SUMMARY OF THE INVENTION

In accordance with the present invention, there is provided a lock device, comprising a locking unit, a protective unit surrounding the locking unit, and a key unit extending through the protective unit and detachably engaging the locking unit to lock or unlock the locking unit. The locking unit includes a lock head and a recessed lock core rotatably mounted in the lock head. The protective unit includes a rotation member surrounding the lock core of the locking unit and a follower combined with the rotation member and surrounding the lock head of the locking unit. The locking unit is sandwiched and hidden between the rotation member and the follower. The rotation member of the protective unit has a central portion provided with an elongate passage aligning with the lock core of the locking unit. The rotation member of the protective unit has a peripheral wall provided with an elongate opening connected to the passage. The key unit includes a key inserted through the passage of the rotation member into the lock core of the locking unit to rotate the lock core of the locking unit relative to the lock head of the locking unit and a drive handle connected with the key and driven by the rotation member of the protective unit to drive and rotate the key relative to the lock core of the locking unit.

The primary objective of the present invention is to provide a lock device having a hidden locking unit.

Another objective of the present invention is to provide a lock device, wherein the locking unit is hidden in and protected by the protective unit to prevent the lock core of the locking unit from being exposed outwardly from the protective unit so that a person cannot see the inner construction of the lock core and cannot unlock the lock core easily.

A further objective of the present invention is to provide a lock device, wherein the opening of the rotation member is perpendicular to the lock core of the locking unit so that a thief cannot use a tool to break the lock core of the locking unit so as to achieve burglarproof function.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a lock device in accordance with the preferred embodiment of the present invention.

FIG. 2 is an exploded perspective view of the lock device as shown in FIG. 1.

FIG. 3 is a partially perspective cross-sectional view of the lock device as shown in FIG. 1.

FIG. 4 is a side cross-sectional view of the lock device as shown in FIG. 1.

FIG. 5 is a schematic operational view of the lock device as shown in FIG. 1 in use.

FIG. 6 is a perspective view of a lock device in accordance with another preferred embodiment of the present invention.

FIG. 7 is a perspective view of a conventional lock device in accordance with the prior art.

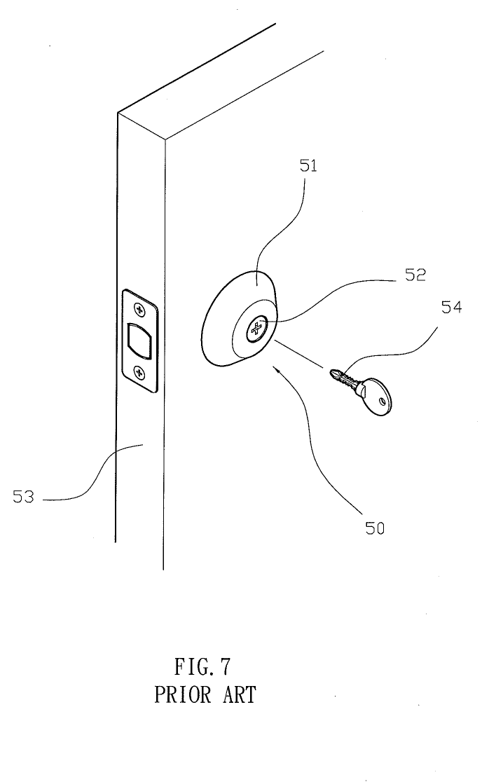

### DETAILED DESCRIPTION OF THE INVENTION

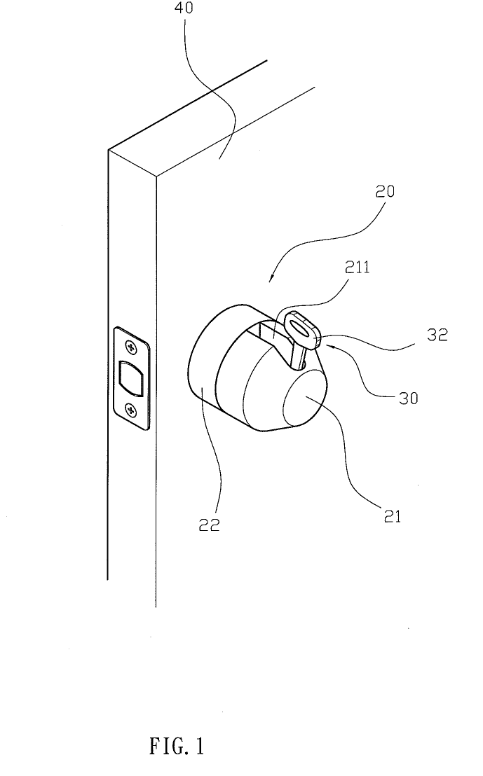

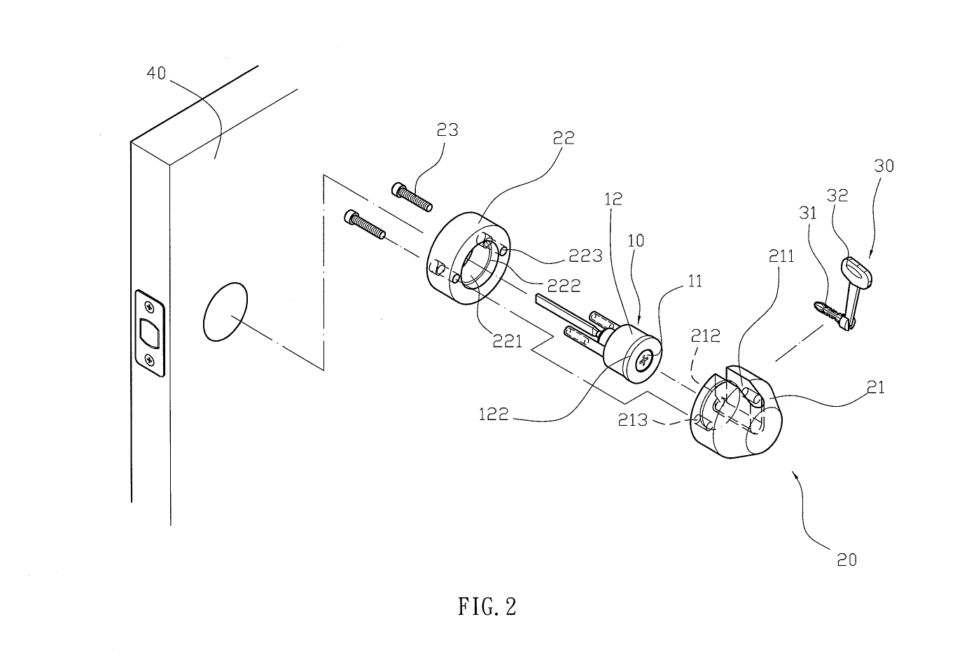

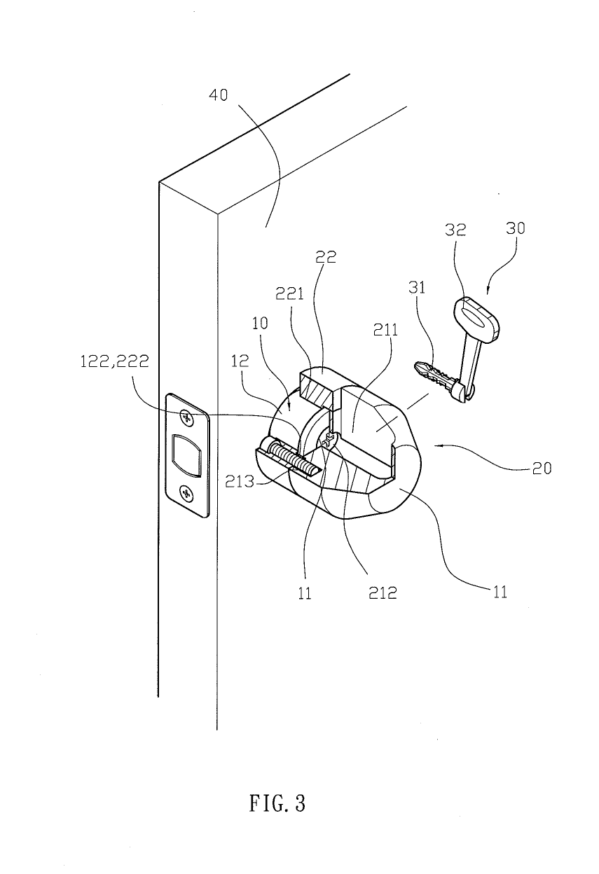

Referring to the drawings and initially to FIGS. 1-5, a lock device in accordance with the preferred embodiment of the present invention comprises a locking unit 10, a protective unit 20 surrounding the locking unit 10, and a key unit 30 extending through the protective unit 20 and detachably engaging the locking unit 10 to lock or unlock the locking unit 10.

The locking unit 10 is mounted on a door 40 and includes a lock head 12 and a recessed lock core 11 rotatably mounted in the lock head 12. The lock head 12 of the locking unit 10 has an end portion provided with an enlarged stop flange 122.

The protective unit 20 is rotatably mounted on the locking unit 10. The protective unit 20 includes a rotation member 21 surrounding the lock core 11 of the locking unit 10 and a follower 22 combined with the rotation member 21 and surrounding the lock head 12 of the locking unit 10 so that the locking unit 10 is sandwiched and hidden between the rotation member 21 and the follower 22.

The rotation member 21 of the protective unit 20 is rotatable relative to the lock core 11 of the locking unit 10. The rotation member 21 of the protective unit 20 has a central portion provided with an elongate passage 212 aligning with the lock core 11 of the locking unit 10 and has a peripheral wall provided with an elongate opening 211 connected to the passage 212. The passage 212 of the rotation member 21 extends in an axial direction of the rotation member 21. The rotation member 21 of the protective unit 20 is rotatable about the passage 212. The opening 211 of the rotation member 21 extends in the axial direction of the rotation member 21 and is perpendicular to the lock core 11 of the locking unit 10. The rotation member 21 of the protective unit 20 has an end face provided with two radially opposite screw bores 213.

The follower 22 of the protective unit 20 laminates the rotation member 21 and is rotatable relative to the lock head 12 of the locking unit 10. The follower 22 of the protective unit 20 has an inner portion provided with a mounting hole 221 rotatably mounted on the lock head 12 of the locking unit 10. The mounting hole 221 of the follower 22 has an end portion provided with an enlarged stop shoulder 222 abutting the stop flange 122 of the lock head 12. The follower 22 of the protective unit 20 has an end face provided with two radially opposite through holes 223.

The protective unit 20 further includes two locking screws 23 extending through the through holes 223 of the follower 22 respectively and are screwed into the screw bores 213 of the rotation member 21 respectively to combine the rotation member 21 and the follower 22 together.

The key unit 30 has a substantially L-shaped profile. The key unit 30 includes a key 31 inserted through the passage 212 of the rotation member 21 into the lock core 11 of the locking unit 10 to rotate the lock core 11 of the locking unit 10 relative to the lock head 12 of the locking unit 10 and a drive handle 32 connected with the key 31 and driven by the rotation member 21 of the protective unit 20 to drive and rotate the key 31 relative to the lock core 11 of the locking unit 10.

The key 31 of the key unit 30 extends through the opening 211 into the passage 212 of the rotation member 21. The drive handle 32 of the key unit 30 is pivotally connected with the key 31. The drive handle 32 of the key unit 30 is inserted through the opening 211 of the rotation member 21 to move the key 31 to align with the passage 212 of the rotation member 21 and the lock core 11 of the locking unit 10. The drive handle 32 of the key unit 30 is movable in and partially protrudes outwardly from the opening 211 of the rotation member 21.

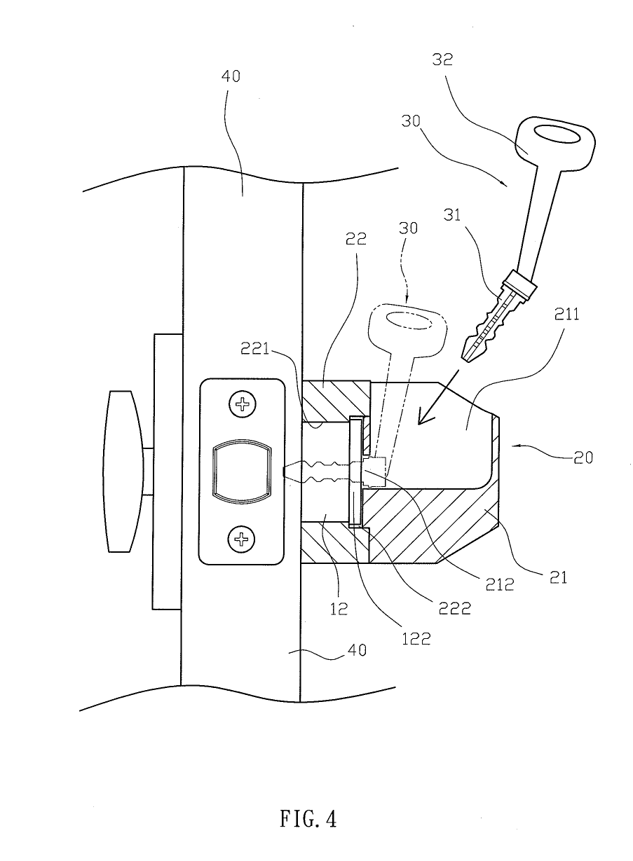

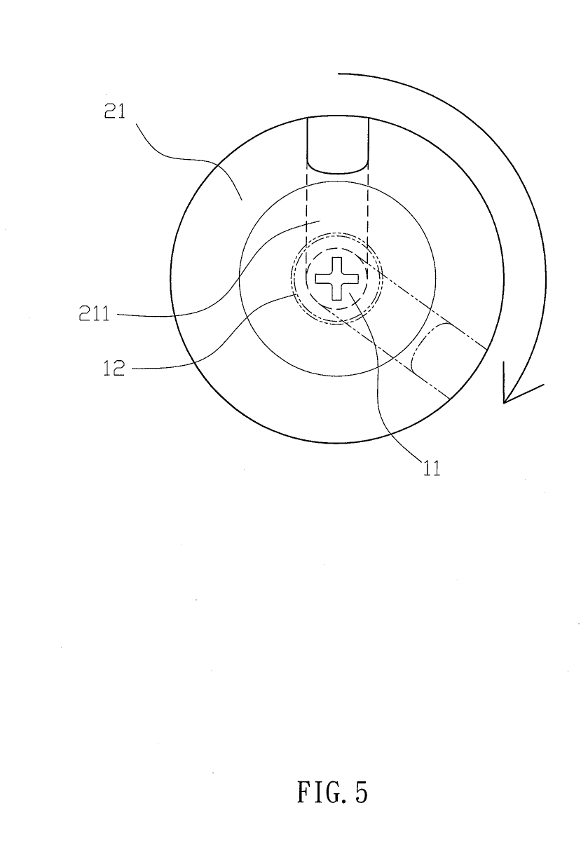

In operation, referring to FIGS. 4 and 5 with reference to FIGS. 1-3, the drive handle 32 of the key unit 30 is inserted through the opening 211 of the rotation member 21 to move the key 31 to align with the passage 212 of the rotation member 21. Then, the drive handle 32 of the key unit 30 is moved in the opening 211 of the rotation member 21 to insert the key 31 through the passage 212 of the rotation member 21 into the lock core 11 of the locking unit 10. Then, the rotation member 21 of the protective unit 20 is rotated relative to the locking unit 10 to drive the drive handle 32 which drives and rotates the key 31 relative to the lock core 11 of the locking unit 10 so that the lock core 11 of the locking unit 10 is rotated by the key 31 to lock or unlock the locking unit 10.

As shown in FIG. 1, the lock device is available for a door lock.

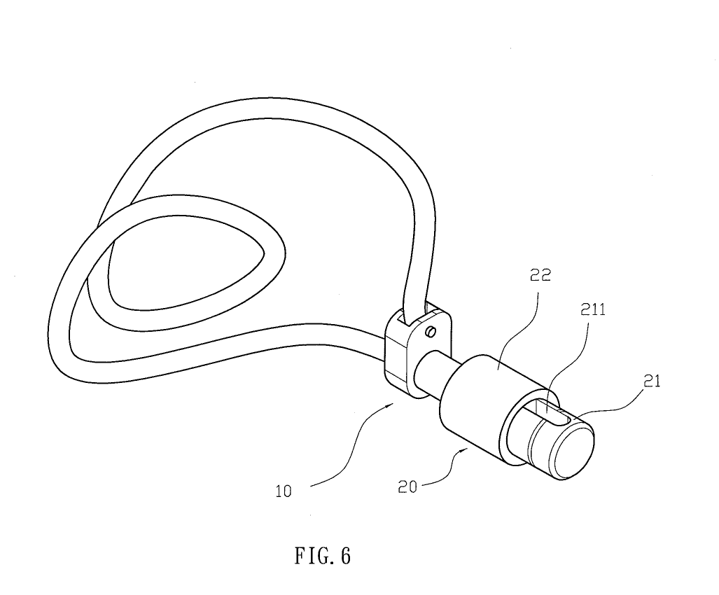

As shown in FIG. 6, the lock device is available for a cable lock.

Accordingly, the locking unit 10 is hidden in and protected by the protective unit 20 to prevent the lock core 11 of the locking unit 10 from being exposed outwardly from the protective unit 20 so that a person cannot see the inner construction of the lock core 11 and cannot unlock the lock core 11 easily. In addition, the opening 211 of the rotation member 21 is perpendicular to the lock core 11 of the locking unit 10 so that a thief cannot use a tool to break the lock core 11 of the locking unit 10 so as to achieve burglarproof function.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lock device, comprising:
a locking unit;
a protective unit surrounding the locking unit;
a key unit extending through the protective unit and detachably engaging the locking unit to lock or unlock the locking unit.

2. The lock device of claim 1, wherein
the locking unit includes:
a lock head;
a recessed lock core rotatably mounted in the lock head;
the protective unit includes:
a rotation member surrounding the lock core of the locking unit;
a follower combined with the rotation member and surrounding the lock head of the locking unit;
the locking unit is sandwiched and hidden between the rotation member and the follower.

3. The lock device of claim 2, wherein
the rotation member of the protective unit has a central portion provided with an elongate passage aligning with the lock core of the locking unit;
the rotation member of the protective unit has a peripheral wall provided with an elongate opening connected to the passage.

4. The lock device of claim 2, wherein the follower of the protective unit has an inner portion provided with a mounting hole rotatably mounted on the lock head of the locking unit.

5. The lock device of claim 4, wherein
the lock head of the locking unit has an end portion provided with an enlarged stop flange;
the mounting hole of the follower has an end portion provided with an enlarged stop shoulder abutting the stop flange of the lock head.

6. The lock device of claim 2, wherein
the follower of the protective unit has an end face provided with two radially opposite through holes;
the rotation member of the protective unit has an end face provided with two radially opposite screw bores.
the protective unit further includes two locking screws extending through the through holes of the follower respectively and are screwed into the screw bores of the rotation member respectively to combine the rotation member and the follower together.

7. The lock device of claim 3, wherein the key unit includes:
a key inserted through the passage of the rotation member into the lock core of the locking unit to rotate the lock core of the locking unit relative to the lock head of the locking unit;
a drive handle connected with the key and driven by the rotation member of the protective unit to drive and rotate the key relative to the lock core of the locking unit.

8. The lock device of claim 7, wherein the key unit has a substantially L-shaped profile.

9. The lock device of claim 7, wherein the key of the key unit extends through the opening into the passage of the rotation member.

10. The lock device of claim 7, wherein the drive handle of the key unit is pivotally connected with the key.

11. The lock device of claim 7, wherein the drive handle of the key unit is inserted through the opening of the rotation member to move the key to align with the passage of the rotation member and the lock core of the locking unit.

12. The lock device of claim 7, wherein the drive handle of the key unit is movable in and partially protrudes outwardly from the opening of the rotation member.

13. The lock device of claim 3, wherein the opening of the rotation member is perpendicular to the lock core of the locking unit.

14. The lock device of claim 2, wherein the follower of the protective unit laminates the rotation member.

15. The lock device of claim 2, wherein the protective unit is rotatably mounted on the locking unit.

16. The lock device of claim 15, wherein the rotation member of the protective unit is rotatable relative to the lock core of the locking unit.

17. The lock device of claim 3, wherein the passage of the rotation member extends in an axial direction of the rotation member.

18. The lock device of claim 3, wherein the rotation member of the protective unit is rotatable about the passage.

19. The lock device of claim 3, wherein the opening of the rotation member extends in an axial direction of the rotation member.

20. The lock device of claim 2, wherein the follower of the protective unit is rotatable relative to the lock head of the locking unit.
